(19) United States
(12) Patent Application Publication
(10) Pub. No.: US 2008/0320510 A1
(43) Pub. Date: Dec. 25, 2008

(54) SHARING VIEWING STATISTICS

(75) Inventors: Curtis G. Wong, Medina, WA (US); Dale A. Sather, Seattle, WA (US); Kenneth Reneris, Clyde Hill, WA (US); Thaddeus C. Pritchett, Edmonds, WA (US); Talal A. Batrouny, Sammamish, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/767,349

(22) Filed: Jun. 22, 2007

(51) Int. Cl. H04N 7/173

(52) U.S. Cl. 725/24

(57) ABSTRACT

A content recommendation system and methodology is provided in which various demographic information and viewing information is obtained from multiple viewers and recommendations of video content to view are provided to a viewer based on the viewer's demographic profile and the viewing preferences of other viewers with the same or similar demographic profile. The recommendations are a result of data mining the aggregated viewing information. Other feedback, such as real-time statistics or likes/dislikes, can also be provided for presentation to the viewer.

### TECHNICAL FIELD

This disclosure is related to collecting and analyzing demographic and viewing information from viewers and using the analyzed information to offer recommended viewing selections and other feedback to viewers.

### BACKGROUND

The amount of video content available to viewers is increasing rapidly. Americans are no longer restricted to the major networks for most of their television viewing. Cable and satellite television continue to offer more and more niche programming, such as whole channels devoted to golf, fishing, a particular sports team, and biographies. As a result, traditional methods of collecting viewing habits and using the aggregated demographic have been strained.

Traditional methods of collecting viewing habits have included surveys and automated black boxes, such as those used by Neilson Media Company to produce the Neilson ratings. However, there are a number of difficulties with surveys and automated black boxes for collecting viewing habits. First, surveys and black boxes tend to rely on relatively large strata, such as high-level genres, large age grouping, metropolitan areas, etc., in order to determine a demographic profile. Surveys and black boxes also often fail to capture information well for anything other than the primary scheduled content, such as a breaking news story, a sporting event that goes into overtime, or advertisements presented during a commercial break. Surveys and black boxes also usually fail to integrate viewing information on video content that is not part of a live broadcast, such as content recorded for future playback or viewer-acquired content (e.g., DVD and VCR tapes). Finally, surveys do not provide real-time capture of viewing information.

Traditional techniques also fail to provide benefits to the viewers. Surveys and black boxes are focused on obtaining the viewer information for the benefit of studios, advertisers, and the networks, not viewers. Even when the traditional techniques do, a lag time exists between data collection and use of the viewing data.

The above-described deficiencies are merely intended to provide an overview of some of the problems of today's viewing techniques, and are not intended to be exhaustive. Other problems with the state of the art may become further apparent upon review of the description of various non-limiting embodiments of the invention that follows.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

According to one aspect of the invention, a content recommendation method and system is provided. Numerous viewers, such as viewers with a particular type of digital video recording device, each provide a demographic profile along with information on the video content the viewer watches. In addition to live television broadcast, the video content can also include purchased/leased video content (e.g., DVDs, VCR tapes). The viewer can then get recommendations of content to watch based on what other viewers with a similar demographic are watching. Statistics, ranking and other feedback can be shared between the viewers.

According to another aspect of the invention, a content reaction method and system is provided. Numerous viewers, provide information about the video content they are watching, as well as a demographic profile. Statistics of what other viewers with similar demographic profiles are watching are generated in real-time and can be presented to the viewers. Viewers can also rank the content and vote on their favorite moment and have that feedback presented to them as well. The content reaction and statistics can also be shared with non-viewers, such as advertisers, studios, and the networks.

The following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and distinguishing features of the claimed subject matter will become apparent from the following detailed description of the claimed subject matter when considered in conjunction with the drawings.

### BRIEF DESCRIPTION OF THE DRAWINGS

FIG. 1 illustrates a schematic block diagram of an exemplary computing environment.

FIGS. 2A-2B is a block diagram of exemplary components of a statistics server in a content recommendation system according to one embodiment.

FIG. 3 is a block diagram of exemplary components of a digital video recording device according to one embodiment.

FIG. 4 depicts an example user interface for providing demographic information.

FIGS. 5A-5B are example user interfaces for providing recommendations and statistical information.

FIG. 6 depicts an exemplary flow chart of the statistics server of the content recommendation system.

FIG. 7 is an exemplary flow chart of a content client of the content recommendation system according to one embodiment.

FIG. 8 illustrates a block diagram of a computer operable to execute the disclosed architecture.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “module,” “system”, or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . smart cards, and flash memory devices (e.g. card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

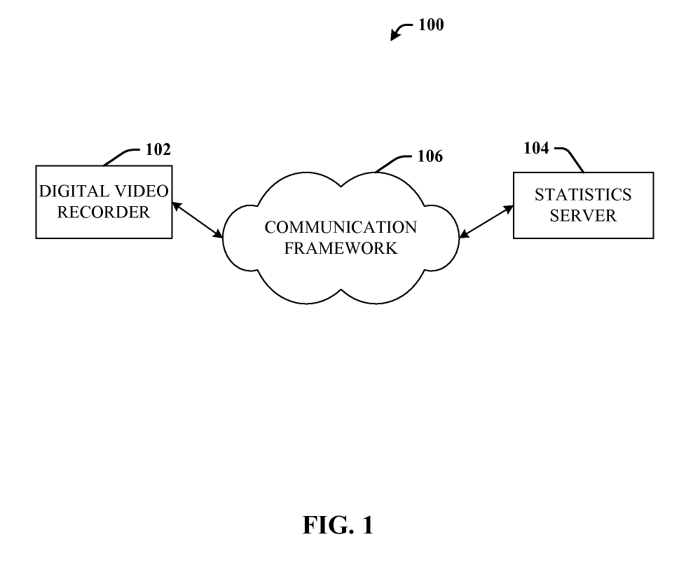

Referring now to FIG. 1, there is illustrated a schematic block diagram of an exemplary computing environment in which the system is used. For the sake of simplicity, only a single machine of each type is illustrated, but one skilled in the art will appreciate that there can be (and usually are) multiple machines of any given type and that some of the types may have their functionality distributed between various computers. For example, in at least one embodiment, the service servers 104 are distributed among two or more servers.

The system 100 includes digital video recording devices 102, statistics server 104, and a communication framework 106. The digital video recording devices 102 are clients that supply viewing information and demographic information to the statistics server. Viewing information includes the viewing history of a particular user and can also include the length of time watched and the format (e.g. high definition vs. standard definition) of the content. The video content can include live broadcast television, recorded content, as well as purchased/leased content (e.g., DVDs and VCR tapes) and downloaded content (e.g., from MovieLink, Apple iTunes Video, Amazon Unbox, etc). In response, recommendations for the viewer can be received back from the statistics server, as well as real-time statistics and feedback from other viewers. One will appreciate that other devices can acts as a content client and supply the information, such as a television or a set-top box.

The system 100 also includes a statistics server 104. The service server(s) 104 can be hardware and/or software (e.g. threads, processes, computing devices). The statistics service receives and aggregates the viewing information and the demographic information of the viewer who provided that viewing information. In addition, it determines recommendation for an indicated viewer with an indicated demographic profile, such as by performing deep data mining on the received viewing and demographic information. One possible communication between a service client 102 and a service server 104 can be in the form of data packets adapted to be transmitted between two or more computers. The data packets can include the viewing information, requests for statistics or feedback, and requests for recommendations.

The system 100 includes a communication framework 106 (e.g., a global communication network such as the Internet, or an enterprise intranet) that can be employed to facilitate communications between the service client 102, service server 104, and allocation server 108. Communications can be facilitated via a wired (including optical fiber) and/or wireless technology.

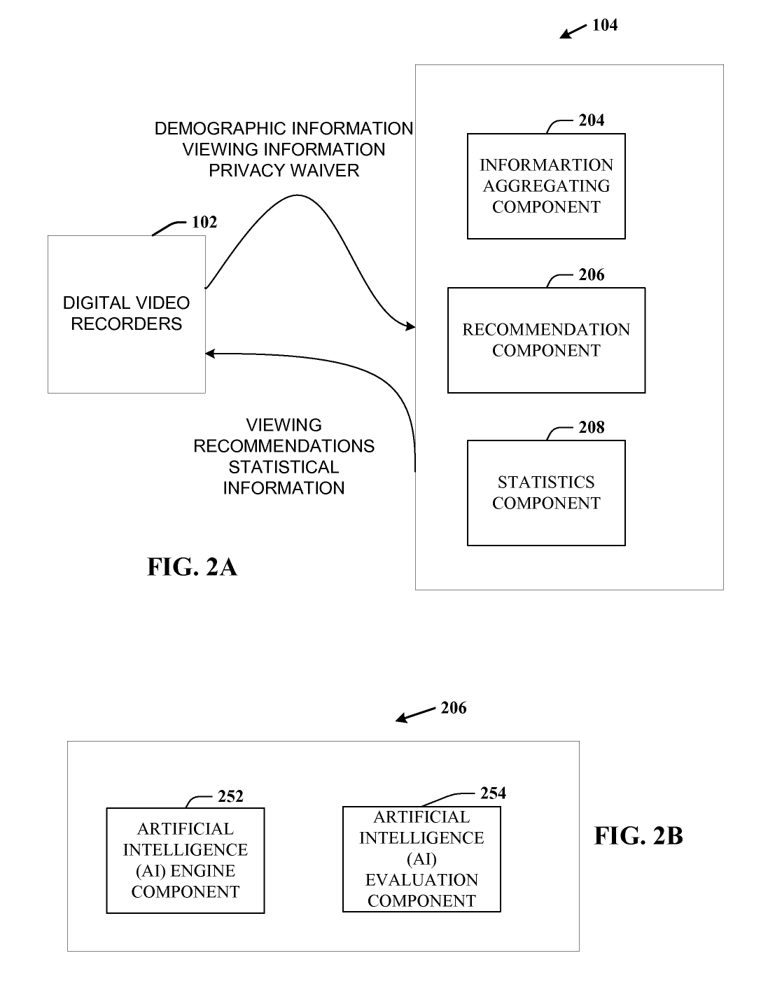

Referring to FIG. 2A, FIG. 2A illustrates the data flow to/from and various components of an exemplary statistics server 104. As previously stated, the digital recording device 102 sends demographic information, viewing information to the statistics server 104. In some embodiments, privacy wavier is also sent. Thus, in some embodiments, a viewer can opt out of providing viewer information, demographic information, or both and as a result may not be able to receive recommendations or statistics. In return, the statistics server 104 returns viewing recommendations and statistical information. Advertisements can also be sent in some embodiments.

The illustrated statistical server 104 contains an information aggregating component 204, a recommendation component 206, and a statistics component 208. The information aggregating component receives the viewing information and demographic information from multiple viewers. In some embodiments, this information is stored in a database (not shown) that is later data mined by the recommendation component 206. The recommendation component 206 determines recommendations for a viewer with an indicated demographic profile. The recommendations can include content that is currently being broadcast, about to start (e.g. within 15 minutes), or purchasable content (i.e. downloadable video content, or DVD content). The statistics component 208 generates various statistics that can be supplied in real-time to viewers, such as 75% of Star Trek fans are viewing this program right now. The statistics can also be supplied to studios, advertisers, and the television networks.

Referring to FIG. 2B, an example block diagram of the recommendation component 206 is depicted The AI engine component 252 can include an inference component (not shown) that can further enhance automated aspects of the AI component utilizing, in part, inference based schemes to facilitate inferring video content the user is interested may be interested in viewing. The AI-based aspects of the invention can be effected via any suitable machine-learning based technique and/or statistical-based techniques and/or probabilistic-based techniques.

One such AI technique, a classifier is a function that maps an input attribute vector, x=(x1, x2, x3, x4, xn), to a confidence that the input belongs to a class, that is, f(x)=confidence (class). The class can represent, for example, a group of people with the same or similar demographic profiles. Since it is contemplated that numerous users will provide viewing information, there will be a large number of distinct demographic profile groups. Such classification can employ a probabilistic and/or statistical-based analysis (e.g., factoring into the analysis utilities and costs) to infer a recommended video source action for the user or to infer an action that a user desires to be automatically performed (e.g., changing the channel during a commercial break or toggling picture and picture).

A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g. naïve Bayes, Bayesian networks, decision trees, and probabilistic classification models providing different patterns of independence can be employed. Classification as used herein also is inclusive of statistical regression that is utilized to develop models of priority.

The artificial intelligence component 208 can employ various artificial intelligence based schemes for recommending video content based on the viewing information of other users and demographic profile of the viewer receiving the recommendations. Specifically, artificial intelligence engine and evaluation components 252, 254 can be associated with the recommendation component. Further, the artificial intelligence engine and evaluation components 302, 304 can be employed to facilitate automatic actions that it is inferred the user desires performed (e.g., automatically tuning to a program that has a high degree of confidence that the viewer wants to watch it).

Various directed and undirected model classification approaches include, e.g. naïve Bayes, Bayesian networks, decision trees, and probabilistic models providing different patterns of independence can be employed by the AI engine component 252. Classification as used herein also is inclusive of statistical regression that is utilized to determine the recommendations.

As will be readily appreciated, the system can employ classifiers that are implicitly trained (e.g. via the viewing information and demographic information received). The use of expert systems, fuzzy logic, support vector machines, greedy search algorithms, rule-based systems, Bayesian models (e.g., Bayesian networks), neural networks, other non-linear training techniques, deep data mining, data fusion, utility-based analytical systems, systems employing Bayesian models, etc. are contemplated and are intended to fall within the scope of the hereto appended claims.

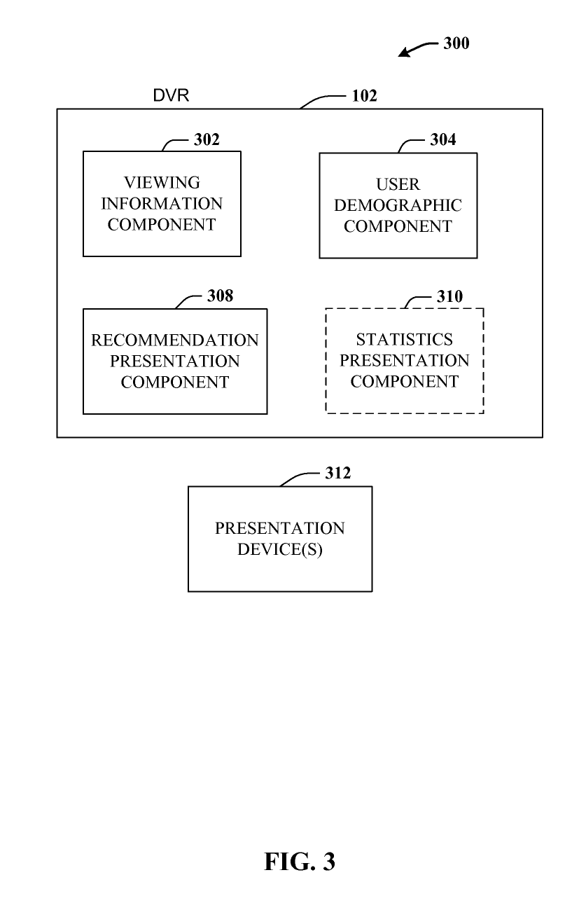

Referring to FIG. 3, FIG. 3 illustrates examples of various components and devices associated with the digital video recording device 102 according to one embodiment. A presentation device 312 is used to present the video content. By way of example, the presentation device can be a television, a projector, or computer monitor. The components include viewing information component 302, user demographic component 304, recommendation presentation component 308, and statistics presentation component 310. The viewing information component tracks what content the user is viewing (including non-live broadcasts) and shares it periodically with the statistics server. For example, it can update the statistics server every 30 seconds on the viewer is currently viewing. The user demographic component 304 maintains the user's demographic information and transmits it to the statistics server in accordance with the user's privacy policy. By way of example, this can include presenting a user interface to allow demographic information to be supplied. The recommendations component 308 receives recommendations from the statistics server and presents them to the user, such as on a customized home page. The statistics component 310 similarly presents real-time statistics supplied via the statistics server, as well as, feedback from other users.

One skilled in the art will appreciate that the components illustrated in FIG. 2A-2B and FIG. 3 are exemplary. The functionality can be distributed in other embodiments in other manners (e.g., more components or fewer components). Additionally, some of the functionality may not be implemented in other embodiments.

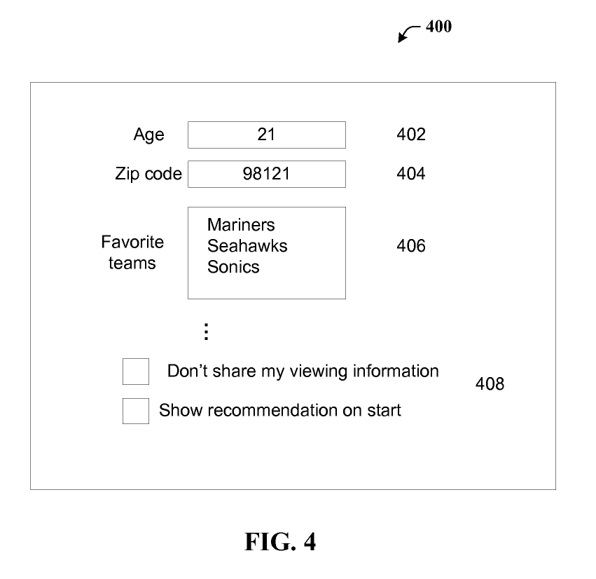

Referring to FIG. 4, a user interface 400 for specifying a demographic profile of the user and user privacy and presentation preferences is illustrated. Various demographic questions, such as age 402, zip code 404, and favorite teams 406 are illustrated, but one skilled in the art will appreciate that various other demographic factors can be also be obtained. By way of example, demographic factors that can be used include, but are not limited to, gender, religious affiliation, education, occupation, income, hobbies, likes, dislikes, favorite foods, and school affiliations. Various other information 408 can also be obtained, such as privacy preferences and preferences regarding presenting recommendations and/or statistics.

Although not shown, in one embodiment, each viewer in a household has his/her own demographic profile and viewing information. In some embodiments, a collective user, such as a mother and son, can have a shared demographic profile and viewing information so that recommendations can be received for content appropriate for both individual users. In some embodiments, each user needs to enter a password to access his/her own profile.

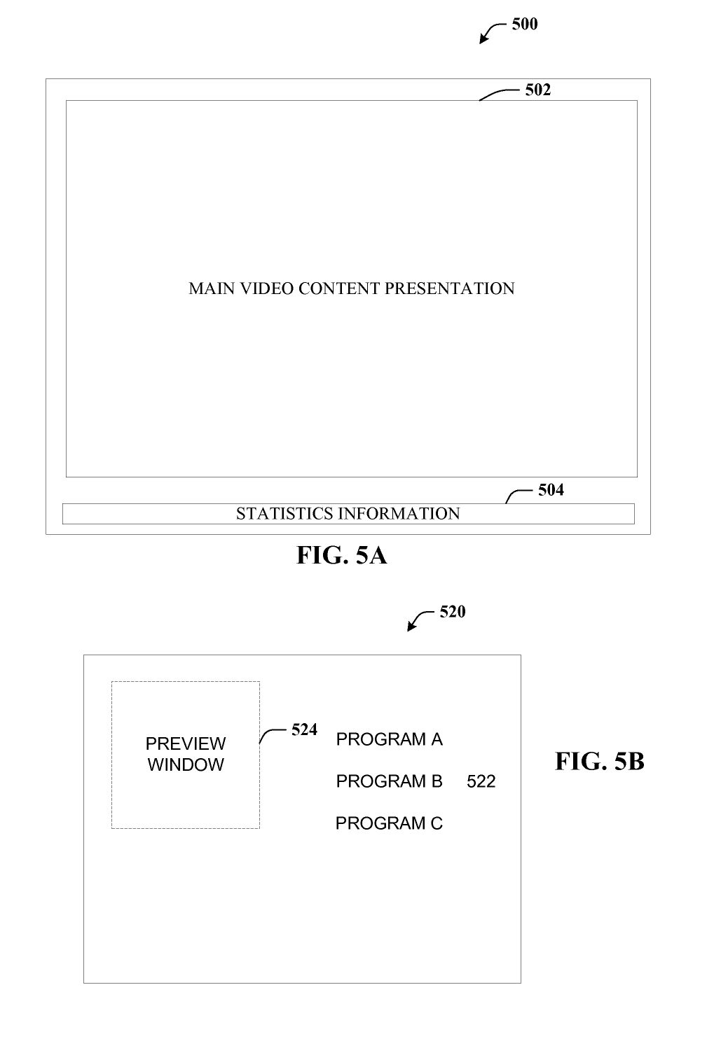

Referring to FIGS. 5A-5B, user interfaces for presenting the real-time statistics and program recommendations are illustrated. In particular, FIG. 5A illustrates a user interface 500 for the presentation of the statistics. In this example, the user interface includes both a main content presentation area 502 and statistics information 506. By way of example, the statistics information can be scrolling text at the bottom of the user interface. In other embodiments, the statistics information can be superimposed onto the main video content. In addition, in some embodiments, the user can determine where to present the statistics information 506. Other feedback information, such as ranking, votes, or commentary can be displayed in a similar manner.

FIG. 5B illustrates a customized home page 520 containing program recommendations 522 and a preview window 524 on that can be displayed when the television is turned on or when a user-selectable guide control is selected by the user. The listing of recommendations 522 is dynamic and will update periodically (e.g., every 30 minutes as old programs finish and new ones start). Other information, such as information from the electronic program guide, about the recommended programs can be displayed in various embodiments. The preview window allows a preview of the recommended content be viewed before changing to it. A logo of a sponsor (not shown) can be displayed if the recommended content, for example, includes purchasable content, such as a downloadable movie.

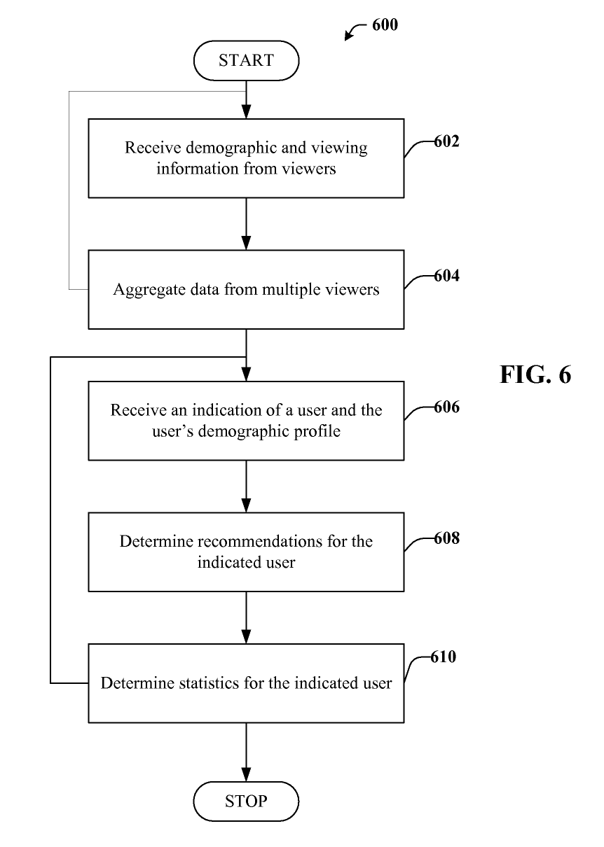

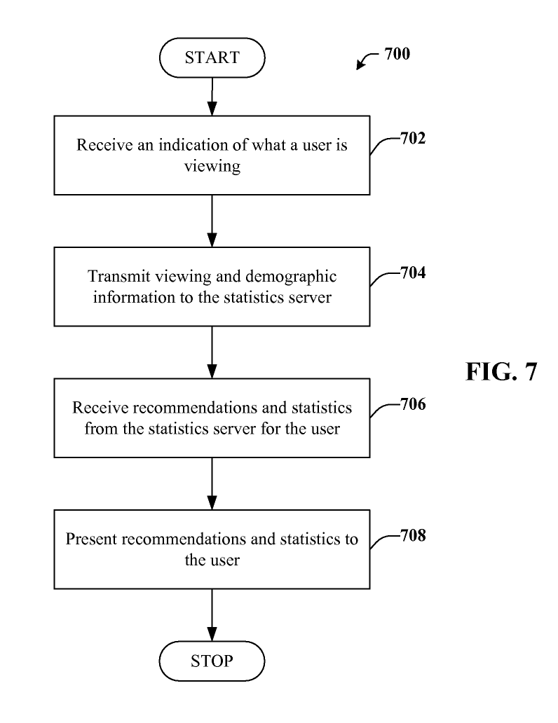

FIGS. 6-7 illustrate various methodologies in accordance with one embodiment. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media. Furthermore, it should be appreciated that although for the sake of simplicity an exemplary method is shown for use on behalf of a single user, the method may be performed for multiple users.

Referring now to FIG. 6, an exemplary method 600 of the statistics server in the content recommendation system is depicted. At 602, viewing information and demographic information from viewers is received. At 604, the data is aggregated. In one embodiment, the data is aggregated together by placing the information into a database. At 606, an indication is received of the user and the user's demographic profile. At 608, recommendations are determined for the indicated user. At 610, statistics are determined for the indicated user and other feedback can also be received. Request for recommendations and receipt of the demographic and viewing information can occur continuously.

Referring now to FIG. 7, an exemplary method 700 is depicted of a content client, such as a digital video recording device. At 702, an indication is received of the content the user is viewing. At 704, viewing and demographic information is transmitted to the statistics server (in accordance with any privacy policy set by the user. The demographic information was previously obtained from the user. At 706, recommendations for the user and statistics are received from the statistics server. At 708, recommendations and the statistics are presented to the user.

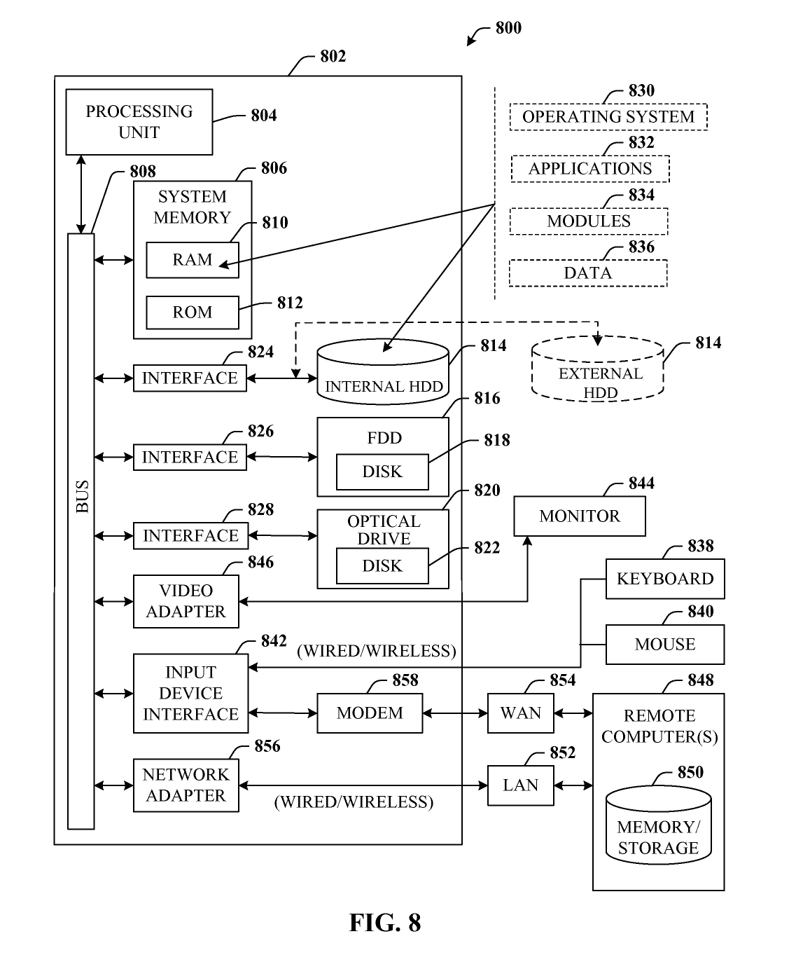

Referring now to FIG. 8, there is illustrated a block diagram of an exemplary computer system operable to execute one or more components of the disclosed allocation system, such as the statistics server. In order to provide additional context for various aspects of the subject invention, FIG. 8 and the following discussion are intended to provide a brief, general description of a suitable computing environment 800 in which the various aspects of the invention can be implemented. Additionally, while the invention has been described above in the general context of computer-executable instructions that may run on one or more computers, those skilled in the art will recognize that the invention also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the invention can be practiced in distributed computing environments where certain tasks are performed by remote processing devices that are linked through a communications network. In at least one embodiment, a distributed computing environment is used for the allocation system in order to insure high-availability, even in the face of a failure of one or more computers executing parts of the allocation system. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media can include both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 8, the exemplary environment 800 for implementing the statistics server includes a computer 802, the computer 802 including a processing unit 804, a system memory 806 and a system bus 808. The system bus 808 couples to system components including, but not limited to, the system memory 806 to the processing unit 804. The processing unit 804 can be any of various commercially available processors. Dual microprocessors and other multi-processor architectures may also be employed as the processing unit 804.

The system bus 808 can be any of several types of bus structure that may further interconnect to a memory bus (with or without a memory controller), a peripheral bus, and a local bus using any of a variety of commercially available bus architectures. The system memory 806 includes read-only memory (ROM) 810 and random access memory (RAM) 812. A basic input/output system (BIOS) is stored in a non-volatile memory 810 such as ROM, EPROM, EEPROM, which BIOS contains the basic routines that help to transfer information between elements within the computer 802, such as during start-up. The RAM 812 can also include a high-speed RAM such as static RAM for caching data.

The computer 802 further includes an internal hard disk drive (HDD) 814 (e.g., EIDE, SATA), which internal hard disk drive 814 may also be configured for external use in a suitable chassis (not shown), a magnetic floppy disk drive (FDD) 816, (e.g., to read from or write to a removable diskette 818) and an optical disk drive 820, (e.g. reading a CD-ROM disk 822 or, to read from or write to other high capacity optical media such as the DVD). The hard disk drive 814, magnetic disk drive 816 and optical disk drive 820 can be connected to the system bus 808 by a hard disk drive interface 824, a magnetic disk drive interface 826 and an optical drive interface 828, respectively. The interface 824 for external drive implementations includes at least one or both of Universal Serial Bus (USB) and IEEE1384 interface technologies. Other external drive connection technologies are within contemplation of the subject invention.

The drives and their associated computer-readable media provide nonvolatile storage of data, data structures, computer-executable instructions, and so forth. For the computer 802, the drives and media accommodate the storage of any data in a suitable digital format. Although the description of computer-readable media above refers to a HDD, a remote computers, such as a remote computer(s) 848. The remote computer(s) 848 can be a workstation, a server computer, a router, a personal computer, portable computer, microprocessor-based entertainment appliance, a peer device or other common network node, various media gateways and typically includes many or all of the elements described relative to the computer 802, although, for purposes of brevity, only a memory/storage device 850 is illustrated. The logical connections depicted include wired/wireless connectivity to a local area network (LAN) 852 and/or larger networks, e.g., a wide area network (WAN) 854. Such LAN and WAN networking environments are commonplace in offices and companies, and facilitate enterprise-wide computer networks, such as intranets, all of which may connect to a global communications network, e.g. the Internet.

When used in a LAN networking environment, the computer 802 is connected to the local network 852 through a wired and/or wireless communication network interface or adapter 856. The adapter 856 may facilitate wired or wireless communication to the LAN 852, which may also include a wireless access point disposed thereon for communicating with the wireless adapter 856.

When used in a WAN networking environment, the computer 802 can include a modem 858, or is connected to a communications server on the WAN 854, or has other means for establishing communications over the WAN 854, such as by way of the Internet. The modem 858, which can be internal or external and a wired or wireless device, is connected to the system bus 808 via the serial port interface 842. In a networked environment, program modules depicted relative to the computer 802, or portions thereof, can be stored in the remote memory/storage device 850. It will be appreciated that the network connections shown are exemplary and other means of establishing a communications link between the computers can be used.

What has been described above includes examples of the various embodiments. It is, of course, not possible to describe every conceivable combination of components or methodologies for purposes of describing the embodiments, but one of ordinary skill in the art may recognize that many further combinations and permutations are possible. Accordingly, the detailed description is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g. a functional equivalent), even though not structurally equivalent to the disclosed structure, which performs the function in the herein illustrated exemplary aspects of the embodiments. In this regard, it will also be recognized that the embodiments includes a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A content recommendation system comprising:
an information aggregating component that receives demographic and viewing information regarding a plurality of viewers; and
a recommendation component that determines viewing recommendations for a viewer with an indicated demographic profile.

2. The system of claim 1, further comprising a statistics component that determines real-time statistics for a particular piece of video content in an indicated demographic profile.

3. The system of claim 2, the statistics component providing the determined real-time statistics to a device associated with a viewer for real-time presentation of the statistics.

4. The system of claim 1, wherein the demographic information includes at least one of favorite sports teams, hobbies, occupation, education or religious affiliation.

5. The system of claim 1, wherein the demographic information includes favorite sports teams, hobbies, occupation, education or religious affiliation.

6. The system of claim 1, the recommendation component associated with an artificial intelligence component that facilitates determining the viewing recommendations.

7. The system of claim 1, the information aggregating component receiving demographic and viewing information from each of the plurality of viewers via a digital video recording device of the viewer.

8. The system of claim 1, the recommendation component providing the determined viewing recommendations to a device associated with the viewer with the indicated demographic profile.

9. A content reaction method comprising:
receiving demographic and viewing information regarding a plurality of viewers; and
providing viewer reaction to an indicated piece of video content based on the viewing information of other viewers that share a common demographic to the viewer.

10. The method of claim 9, further comprising:
receiving an indication of demographic profile of an indicated viewer; and
providing viewing recommendations to the indicated viewer based on the viewing information of other viewers that share a common demographic to the indicated viewer.

11. The method of claim 9, wherein the providing of the viewer reaction to an indicated viewer based on the viewing information of other viewers that share a common demographic to the viewer includes providing real-time viewing statistics.

12. The method of claim 9, wherein the providing of the viewer reaction to an indicated viewer based on the viewing information of other viewers that share a common demographic to the viewer includes providing dynamic ratings of the content by the other viewers that share the common demographic.

13. The method of claim 9 wherein the receiving of demographic and viewing information regarding a plurality of viewers includes receiving demographic and viewing information from each of the plurality of viewers via a digital video recorder or set-top box.

14. The method of claim 9 wherein the providing of the viewing reaction to an indicated viewer based on the viewing information of other viewers that share a common demographic to the viewer includes providing viewer reaction to an indicated piece of video content.

15. The method of claim 9, wherein the viewing information includes viewing information of at least one of DVD content, recorded content, or downloaded content.

16. A computer-readable medium having computer-executable instructions for performing the method of claim 9.

17. A content recommendation system comprising:
means for creating a demographic profile of the viewer; and
means for presenting viewing recommendations that are based on the demographic profile of the viewer and viewing information obtained from other viewers.

18. The system of claim 17, further comprising:
means for presenting real-time statistics associated with content currently being viewed by the viewer.

19. The system of claim 17, further comprising:
means for capturing information about video content a viewer watches.

20. A digital video recorder comprising the system of claim 17.
